(19) United States
(12) Patent Application Publication
(10) Pub. No.: US 2009/0171546 A1
(43) Pub. Date: Jul. 2, 2009

(54) CONTROL DEVICE FOR STRADDLE-TYPE VEHICLE AND VEHICLE EQUIPPED WITH THE SAME

(75) Inventors: Harutomo Tozuka, Shizuoka (JP); Haruhiko Samoto, Shizuoka (JP); Kosei Maebashi, Shizuoka (JP); Hirokazu Fujita, Shizuoka (JP)

Correspondence Address: JONES DAY, 555 SOUTH FLOWER STREET FIFTIETH FLOOR, LOS ANGELES, CA, 90071, US

(73) Assignee: Yamaha Hatsudoki Kabushiki Kaisha

(21) Appl. No.: 12/341,686

(22) Filed: Dec. 22, 2008

(30) Foreign Application Priority Data
Dec. 26, 2007 (JP) 2007-335094

(51) Int. Cl. G05D 1/00; B60K 5/00

(52) U.S. Cl. 701/93; 180/54.1; 701/1

(57) ABSTRACT

A control device for a straddle-type vehicle includes a first storage means configured to store a target cruise control speed, and a first detection program which senses if the vehicle accelerator is operated in the further closing direction from the totally closed position of the accelerator. The control device also includes a deceleration processing program which decreases the stored target cruise control speed when the first detection program detects the further closing operation during cruise control. The deceleration processing program varies the rate at which the stored target cruise control speed is decreased according to the magnitude of the operating force utilized in the further closing operation.

### PRIORITY INFORMATION

This patent application is based on and claims priority under 35 U.S.C. § 119 to Japanese Patent Application No. 2007-335094, filed on Dec. 26, 2007, the entire contents of which is hereby expressly incorporated by reference.

### TECHNICAL FIELD

The present invention relates to a control device for a straddle-type vehicle that controls the output of the vehicle drive source and a vehicle equipped with the same.

### BACKGROUND ART

Cruise control devices for controlling a constant-running speed in a straddle-type vehicle are disclosed, for example, in Japanese Patent Unexamined Publication No. 2007-113416 and Japanese Unexamined Patent Publication No. 2007-137186. The latter discloses technology related to a constant-running speed control device for a straddle-type vehicle. The technology is configured such that when a vehicle speed desired by a rider is reached, a constant-running speed control is started or turned on by operating a vehicle speed setting switch and is temporarily released only by returning the accelerator (which is also referred to as a throttle grip, an accelerator grip, or an accelerator) in a closing direction (see paragraph 0002 of Japanese Unexamined Patent Publication No. 2007-137186).

As a constant-running speed control device, the same patent document discloses a control device that sets a target throttle opening according to a rider instructed throttle opening conveyed by the rider through the accelerator and which in turn controls the actual throttle opening to the target throttle opening. The control device is configured such that when either the rider instructed throttle opening or the target throttle opening are close to (i.e., are in a specified relationship with) an actual throttle opening and when an amount of change per unit time of the desired throttle opening is compared with a threshold value and the amount of change is the threshold value or more in a negative direction (a release condition is satisfied), the device switches the constant-running speed control to a throttle target opening control. Thus, even if the rider does not return the accelerator to a position where the throttle valve is totally closed, the rider's intention to decrease the vehicle speed can be detected, and hence an unnecessary decrease in the RPM of the engine may be avoided. Therefore, an unnecessary decrease in the output of the engine is avoided and ride comfort is not impaired (see, for example, paragraphs 0028 and 0031 of Japanese Unexamined Patent Publication No. 2007-137186).

Japanese Unexamined Patent Publication No. 2007-113416 discloses a configuration in which, when a rider operates a throttle grip to a return side in an auto-cruise state, a switching mode of a cancel switch is changed and a control unit releases the auto-cruise state according to a change in the switching state. In other words, when the rider turns the accelerator to the return side in the auto-cruise state, the auto-cruise state is released (see, for example, claim 7 and paragraphs 0037, 0046, and 0047 of Japanese Unexamined Patent Publication No. 2007-113416).

When driving a straddle-type vehicle, a rider usually operates the vehicle accelerator in a state where the rider grips the accelerator while sustaining air flow around his or her body. As a result, when the rider drives the straddle-type vehicle at a constant speed for a long time, the load of air pressure applied to the rider becomes large. A constant-running speed control is a control that facilitates the rider's operation of the straddle-type vehicle to decrease the load. The constant-running speed control is used during the driving of a straddle-type vehicle on a road, for example, a highway in which a traffic signal is not disposed and in which the straddle-type vehicle is supposed to be driven at a constant speed.

In the control device for a straddle-type vehicle disclosed in Japanese Unexamined Patent Publication No. 2007-137186, when the amount of change per unit time of the throttle opening instructed through the accelerator by the rider is compared with the threshold value and when the amount of change is the threshold value or more in the negative direction, the constant-running speed control is switched to the throttle target opening control. Moreover, also in the above-mentioned Japanese Unexamined Patent Publication No. 2007-113416, when the rider operates the accelerator to the return side in the auto-cruise state, the auto-cruise state is released.

However, an inconvenience is caused by the configuration in which when the rider operates the accelerator in the closing direction in the auto-cruise state, the constant-running speed control is released. For example, when the rider drives a vehicle under the constant-running speed control and overtakes another vehicle running at a vehicle speed lower than the target vehicle speed of the constant-running speed control, there is a case where the rider decelerates the vehicle speed so as to meet the speed of the other vehicle and then drives the vehicle after the other vehicle so as to meet the speed of the other vehicle. In this case, when the rider overtakes the other vehicle (which is running at a vehicle speed lower than the target vehicle speed of the constant-running speed control), there is a possibility that the rider will operate the accelerator (throttle grip) in the closing direction like the ordinary operation of the accelerator. In situations like this, there is a possibility that the constant-running speed control will be released. When the constant-running speed control is unexpectedly released during the constant-running speed control in this manner, the rider needs to again perform the operation of the constant-running speed control. The present inventor thought that such an operation is too troublesome of an operation for the rider of a straddle-type vehicle, and that it would be desirable to provide a control device for a straddle-type vehicle which eliminates the need for the rider to perform such an operation.

### SUMMARY

A control device for a straddle-type vehicle according to the present invention includes a first storage means for storing a target cruise control speed, and a first detection program for determining if the vehicle accelerator is operated in the further closing direction from a totally closed position of the vehicle accelerator. Further, the control device includes a deceleration processing program which decreases the target cruise control speed stored in the first storage means when the first detection program detects the further closing operation during cruise control operation.

According to the described control device for a straddle-type vehicle, when it is detected that the accelerator is operated in the further closing direction from the totally closed position of the accelerator, the target cruise control speed is decreased. According to the control device for a straddle-type vehicle, when a rider intends to decrease the vehicle speed during cruise control operation, the rider can perform the above operation while gripping the accelerator as usual. Because the operation of closing the accelerator in the further closing direction from the totally closed position is a simple extension of the usual operation of an accelerator at the time of decreasing the vehicle speed, the operability of the straddle-type vehicle is extremely excellent. Further, even when the rider operates the accelerator in the closing direction during cruise control, it is possible to prevent the cruise control from being unexpectedly released.

### BRIEF DESCRIPTION OF THE DRAWINGS

FIG. 1 is a block diagram for describing a control device for a straddle-type vehicle according to one embodiment of the present invention.

FIG. 2 is a side view of straddle-type vehicle equipped with the control device of FIG. 1.

FIG. 3 is a flow chart illustrating a method for controlling a deceleration processing during a constant-running speed control operation for a straddle-type vehicle according to one embodiment of the present invention.

### DETAILED DESCRIPTION

Hereinafter, a control device for a straddle-type vehicle according to one embodiment of the present invention will be described with reference to the accompanying drawings. Here, in the respective drawings, the components and parts performing the same functions are denoted by the same reference symbols. Moreover, the present invention is not limited to the following embodiment.

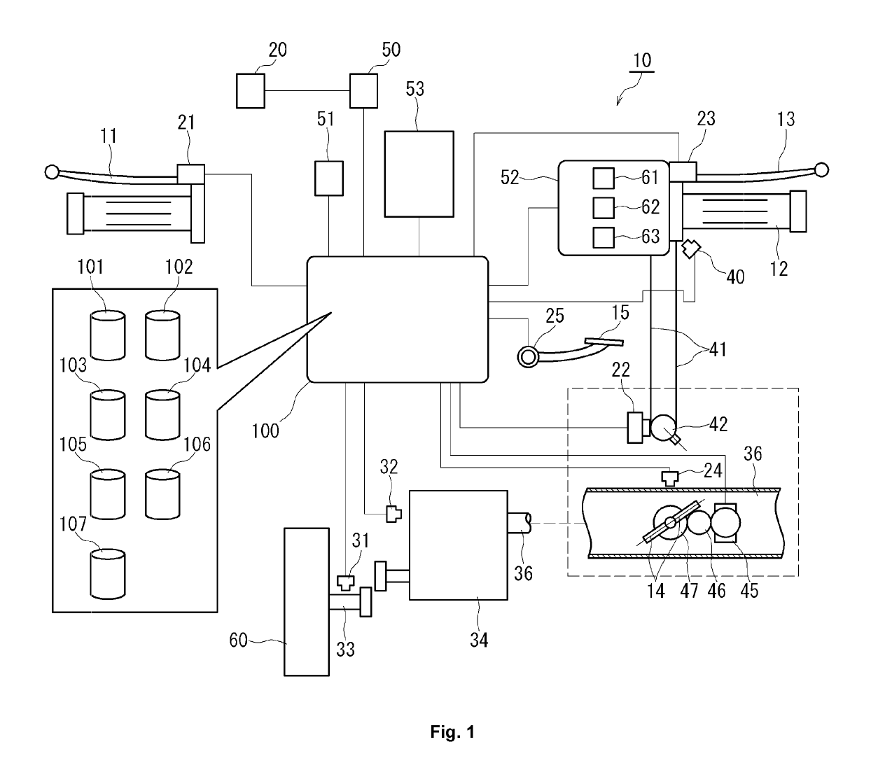

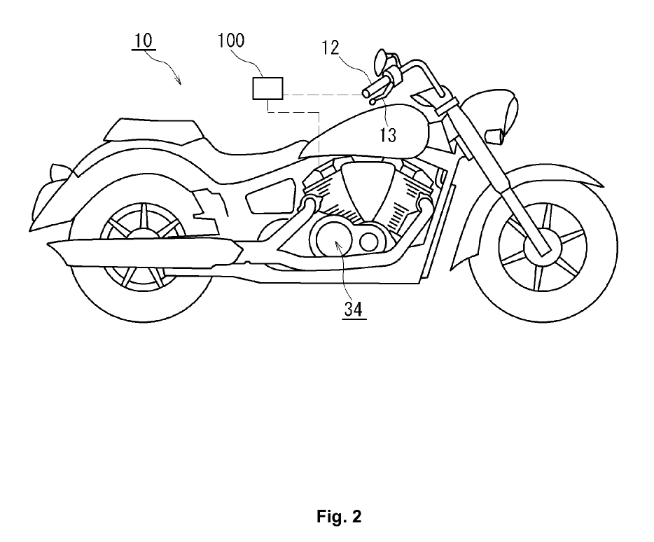

A control device 100 for a straddle-type vehicle, as shown in FIG. 1 and FIG. 2, is operatively mounted on a straddle-type vehicle 10. In this embodiment, the straddle-type vehicle 10, as shown in FIG. 1, is provided with a clutch lever 11, an accelerator 12, a front brake lever 13, a throttle valve 14, and a rear brake pedal 15.

The clutch lever 11, the accelerator 12, the front brake lever 13, the throttle valve 14, and the rear brake pedal 15 are provided with sensors 21 to 25 for detecting their operational state, respectively. Moreover, the straddle-type vehicle 10 is provided with a vehicle speed sensor 31 and an engine revolution speed or rpm (revolutions per minute) sensor 32. The vehicle speed sensor 31 comprises a sensor for detecting the vehicle speed of the straddle-type vehicle 10. In the present embodiment, vehicle speed sensor 31 detects the revolution speed of an axle 33 of a rear wheel 60. The engine revolution speed sensor 32 comprises a sensor for detecting the rotational speed of engine 34 (a drive source). In the present embodiment, engine revolution speed sensor 32 is configured to detect the rotational speed of the crankshaft of the engine 34.

The control device 100 for a straddle-type vehicle is provided with inputs (not shown) through which signals detected by the respective sensors 21 to 25, 31, and 32 are input. Sensors 21 to 25, 31, and 32 are operatively connected to the inputs so as to allow communication of the detection signals of the respective sensors 21 to 25, 31, and 32 with the control device 100.

In this embodiment, the control device 100 comprises an electronic processing device including an operation means comprised of a MPU (Microprocessor Unit) or a CPU (Central Processing Unit) having an operating function, and a storage means comprised of non-volatile memory or the like. The control device 100 for a straddle-type vehicle is programmed to realize a specified function as described more fully below. In the present embodiment, as schematically illustrated in reference to FIG. 1, control device 100 includes a throttle valve opening control program 103 (or output control program), a first detection program 104, and a deceleration processing program 105, which are described below and may be, for example, embodied by separate programs or subroutines of a single program, and make the control device 100 realize specified functions, respectively.

In this embodiment, the drive source 34 of the straddle-type vehicle comprises an internal combustion engine, the output of which is adjusted by the opening/closing of the throttle valve 14. Specifically, the throttle valve 14 is disposed in an intake passage 36 of the engine 34, and the amount of air-fuel mixture flowing into the engine 34 is adjusted by the amount that throttle valve 14 is opened. The amount that throttle valve 14 is opened is referred to as the “opening of the throttle valve 14” herein. In the present embodiment, straddle-type vehicle 10 is provided with an electronic throttle in which the opening of the throttle valve 14 is electronically controlled by a control device.

In this embodiment, when an accelerator 12 is turned, a pulley 42 connected to the accelerator 12 by a cable 41 is driven to rotate in response. The pulley 42 is provided with an accelerator position sensor 22 for detecting the amount of rotation of the pulley 42. The control device 100 determines or detects the amount of rotation of the pulley 42, and, in turn, the operational state of the accelerator 12, based on the detection signal generated by the acceleration position sensor 22. Control device 100 is thus informed of the operational state of accelerator 12 by way of the detection signal received from accelerator position sensor 22.

The control device 100 determines or detects the opening of the throttle valve 14 on the basis of the detection signal provided by the throttle position sensor 24. In this embodiment, the control device 100 is programmed to compute a target value of the opening of the throttle valve 14 (target throttle opening) based on the detection signals received from the acceleration position sensor 22, vehicle speed sensor 31, and engine rpm sensor 32. The control device 100 outputs a control signal to actuator 45 to adjust the opening of the throttle valve 14 to the computed target throttle opening. In this embodiment, the actuator 45 comprises a motor which rotates a rotary shaft 47 of the throttle valve 14 via a gear 46 to vary the opening of the throttle valve 14.

In this manner, in this embodiment, an electronic throttle is employed and the opening of the throttle valve 14 is controlled by the control device 100. Further, the control device 100 is configured to perform a constant-running speed control. The constant-running speed control is also referred to as “cruise control” throughout the present patent document.

In this embodiment, the control device 100 includes a first storage means 101, a throttle valve opening control program 103, a first detection program 104, and a deceleration processing program 105. Moreover, in this embodiment, the straddle-type vehicle 10 is provided with a detection means 40 for detecting whether accelerator 12 is turned in the further closing direction from a totally closed position of the accelerator 12. In this embodiment, detection means 40 is fixed to the accelerator 12 and comprises a pressure detection means, such as a pressure sensor, for detecting the operation and the operating force of the accelerator 12. The pressure sensor 40 performs the function of an operation detection means for detecting when the accelerator 12 is operated in the further closing direction from the totally closed position of the accelerator 12 and the function of an operating force detection means for detecting the magnitude of the operating force of the accelerator 12. The pressure sensor 40 is connected to the control device 100 via an input port (not shown) and the detection signal output from pressure sensor 40 is sent to the control device 100. In other embodiments, the detection means for performing the function of the operation detection means and the detection means for performing the function of the force detection means may comprise separate detection means. For example, the detection means for performing the function of the operation detection means may comprise a switch for detecting that the accelerator 12 is operated in the further closing direction from the totally closed position of the accelerator 12.

Moreover, in this embodiment, the straddle-type vehicle 10 is provided with a main switch 50 for starting the straddle type vehicle 10, a start switch 51 for the constant-running speed control, an operation control panel 52 for operating the constant-running speed control, and a display 53 for displaying the state of the constant-running speed control. In this embodiment, the start switch 51 is a switch that may used to initiate the constant-running speed control (or cruise control) function. In this embodiment, the main switch 50 for starting the whole system of the straddle-type vehicle is turned on or off by turning a key 20 of the straddle-type vehicle 10. The straddle-type vehicle 10 is configured so that even if the main switch 50 is on, when the start switch 51 is off, constant-running speed control is not performed, and only when the main switch 50 is on and the start switch 51 is on, may the constant-running speed control be performed. The operation control panel 52 is disposed near the accelerator 12 and is provided with three switches 61, 62 and 63.

When constant-running speed control is not being performed, a first switch (acceleration/vehicle speed setting switch) 61 functions as an operating switch for performing the constant-running speed control and for setting the target vehicle speed of the constant-running speed control. Moreover, when constant-running speed control is being performed, the first switch 61 functions as an operating switch for accelerating the target vehicle speed of the constant-running speed control.

When constant-running speed control is not being performed, a second switch (deceleration/resume switch) 62 functions as an operating switch for setting the target vehicle speed of the constant-running speed control to the target vehicle speed of the immediately preceding constant-running speed control. Moreover, when the constant-running speed control is being performed, the second switch 62 functions as an operating switch for decelerating the target vehicle speed of the constant-running speed control.

A third switch (cancel switch) 63 functions as an operating switch for releasing the constant-running speed control and returning the constant-running speed control to a normal running control. The above-mentioned respective switches 51, and 61, 62 and 63 are connected to the control device 100 so as to provide input signals to the control device 100.

The first storage means 101 of the control device 100 stores the target vehicle speed of the constant-running speed control. In this embodiment, when the start switch 51 is “off”, the control device 100 is in a state where the constant-running speed control cannot be performed, and the opening of the throttle valve 14 is controlled on the basis of the operation of the accelerator 12, whereby the vehicle speed is adjusted. When the start switch 51 is turned “on”, there is brought about a state in which constant-running speed control can be performed.

When the first switch 61 or the second switch 62 is operated in a state where the start switch 51 is “on”, the target vehicle speed of the constant-running speed control is set according to the target speed value stored in first storage means 101.

In this embodiment, when the constant-running speed control is not being performed in a state where the start switch 51 is “on”, if the first switch 61 is operated, the vehicle speed detected by the vehicle speed sensor 31 when the first switch 61 is operated is stored in the first storage means 101 and becomes the target vehicle speed of the constant-running speed control. Moreover, when constant-running speed control is not being performed in a state where the start switch 51 of the constant-running speed control is “on”, if the second switch 62 is operated, first, the target vehicle speed of the immediately preceding constant-running speed control, which is stored in the first storage means 101, is stored separately in a second storage means 102. Then, when the second switch 62 is operated, the vehicle speed detected by the vehicle speed sensor 31 is stored in the first storage means 101 and the constant-running speed control is started. Thereafter, the target vehicle speed of the constant-running speed control stored in the first storage means 101 is gradually updated in such a way that the target vehicle speed of the constant-running speed control becomes the target vehicle speed of the immediately preceding constant-running speed control stored in the second storage means 102, whereby the target vehicle speed of the constant-running speed control stored in the first storage means 101 is gradually brought close to the target vehicle speed of the immediately preceding constant-running speed control stored in the second storage means 102. With this setup, the target vehicle speed of the constant-running speed control stored in the first storage means 101 is finally brought to the final target vehicle speed of the constant-running speed control stored in the second storage means 102.

Moreover, when the constant-running speed control is being performed in a state where the start switch 51 is “on”, if the first switch 61 is operated, the target vehicle speed of the constant-running speed control stored in the first storage means 101 is reset to a higher vehicle speed. Consequently, the target vehicle speed of the constant-running speed control is increased and hence the running speed of the constant-running speed control is accelerated. Moreover, when constant-running speed control is being performed, if the second switch 62 is operated, the target vehicle speed of the constant-running speed control stored in the first storage means 101 is reset to a lower vehicle speed. Thus, the target vehicle speed in the constant-running speed control is decreased and hence the running speed of the constant-running speed control is decelerated.

The throttle valve opening control program 103 controls the opening of the throttle valve 14 in such a way that the straddle-type vehicle 10 constantly runs at the target vehicle speed stored in the first storage means 101. The throttle valve opening control program 103 receives input on the vehicle speed detected by the vehicle speed sensor 31 and computes a target throttle opening in such a way that the vehicle speed becomes the target vehicle speed. Then, the throttle valve opening control program 103 instructs the control device 100 to output an operating signal to actuator 45 to adjust the opening of the throttle valve 14 to the computed target throttle opening.

In this embodiment, the throttle valve opening control program 103 operates the actuator 45 on the basis of input from the vehicle speed sensor 31 and the throttle position sensor 24 in such a way that the vehicle speed detected by the vehicle speed sensor 31 is brought to the target vehicle speed stored in the first storage means 101. The straddle-type vehicle 10 can be run at a constant speed by utilizing the throttle valve opening control program 103. According to this type of constant-running speed control, even if a rider does not perform a fine adjustment of the accelerator 12 when needed, the opening of the throttle valve 14 can be automatically adjusted, so that the operational load on the rider can be reduced when the vehicle is driven on a highway or the like.

In the present embodiment, the constant-running speed control may be released not only by operation of the third switch 63 of the operation panel 52 but also by operation of the clutch lever 11, the front brake lever 13, or the rear brake pedal 15. That is, the clutch lever 11, the front brake lever 13, or the rear brake pedal 15 can be operated when the rider decelerates the straddle-type vehicle, and when any one of these components is operated, the constant-running speed control is released. When the constant-running speed control is released in this manner, for the rider to perform the constant-running speed control again, the rider needs to operate the first switch 61 or the second switch 62. As described above, the operation panel 52 is provided with a switch (deceleration switch: second switch 62) for reducing the target vehicle speed of the constant-running speed control by an easier operation during the constant-running speed control.

The present embodiment is constructed in such a way that during constant-running speed control, the target vehicle speed of the constant-running speed control can be decreased by an easier operation. That is, in this embodiment, when the accelerator 12 is operated in the further closing direction from the totally closed position of the accelerator 12 during the constant-running speed control, the target vehicle speed of the constant-running speed control can be decreased. Hereinafter, the operation of first detection program 104 and deceleration processing program 105 will be described.

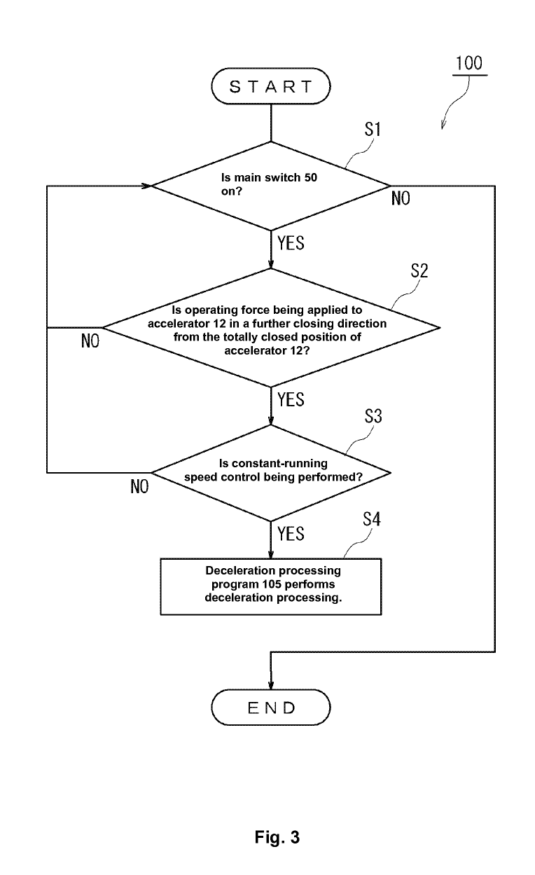

The first detection program or routine 104 detects or determines whether the accelerator 12 is operated in the further closing direction from the totally closed position of the accelerator 12. In this embodiment, the first detection program 104 receives the detection signal of the pressure sensor 40 (operation detection means) as an input and detects or determines based on that signal whether the accelerator 12 is operated in the further closing direction from the totally closed position of the accelerator 12. Here, in this embodiment, the control device 100, as shown in FIG. 3, is started (START) when the main switch 50 for starting the whole system of the straddle-type vehicle 10 is turned on (step S1). If the main switch 50 is turned on (YES), the first detection program 104 is configured to constantly determine whether or not the accelerator 12 is operated in the further closing direction from the totally closed position of the accelerator 12. In other words, in this embodiment, the control device 100 is programmed to perform a determination step (S2) for determining whether or not the accelerator 12 is operated in the further closing direction from the totally closed position of the accelerator 12. When the main switch 50 is turned on (YES), the determination step (S2) determines whether or not the accelerator 12 is operated in the further closing direction from the totally closed position of the accelerator 12. Then, when it is determined in the determination step (S2) that the accelerator 12 is operated in the further closing direction from the totally closed position of the accelerator 12 (YES), it is further determined in step (S3) whether or not the constant-running speed control is being performed. When it is determined in the determination step (S3) that the constant-running speed control is being performed (YES), the control device 100 performs a deceleration processing step (S4) via the deceleration processing program 105. When it is determined in the determination step (S3) that the constant-running speed control is not being performed (NO), the input of the operation detection means 40 is ignored and step S1 of the control flow routine is repeated. In this embodiment, when it is determined in the determination step (S1) that the main switch 50 is turned off, the control flow routine of the control device 100 ceases (END).

If the first detection program 104 determines that the accelerator 12 is operated in the further closing direction from the totally closed position of the accelerator 12 in step S2 and a constant-running speed control is being performed in step S3, the deceleration processing program 105 decreases the target vehicle speed stored in the first storage means 101 in the deceleration processing step S4. When the target vehicle speed stored in the first storage means 101 is decreased, the running speed of the straddle-type vehicle 10, which is under constant-running speed control, is also decreased.

In this embodiment, the deceleration processing program 105 is configured to decrease the target vehicle speed stored in the first storage means 101 during a period of time when the first detection program 104 detects that the accelerator 12 is operated in the further closing direction from the totally closed position of the accelerator 12. In this case, it suffices that the deceleration processing program 105 is configured in such a way as to decrease the target vehicle speed stored in the first storage means 101 at a previously determined rate with respect to time, for example, during a period of time when the first detection program 104 detects the above-mentioned operation. In other embodiments, the deceleration processing program 105 may change the rate at which the target vehicle speed is decreased according to the magnitude of the operating force.

In this embodiment, as described above, when the first detection program 104 detects that the accelerator 12 is operated in the further closing direction from the totally closed position of the accelerator 12 during the constant-running speed control, the control device 100 decreases the target vehicle speed stored in the first storage means 101. In the operation of the straddle-type vehicle 10, it does not happen normally that the accelerator 12 is operated in the further closing direction from the totally closed position of the accelerator 12. By detecting that the accelerator 12 is operated in the further closing direction from the totally closed position of the accelerator 12, the rider's intention of decreasing the vehicle speed can be detected. Moreover, according to the control device 100 of the present embodiment, when the rider intends to decelerate the vehicle while the rider is driving the vehicle under a constant-running speed control condition, the rider can operate the accelerator 12 in a state where the rider grips the accelerator 12 as usual, so the control device 100 for a straddle type vehicle can realize extremely high operability.

Further, when the rider intends to decelerate the vehicle, the rider usually returns the accelerator 12 (that is, the accelerator 12 is closed). The operating of the accelerator 12 in the further closing direction from the totally closed position of the accelerator 12 can be performed as an extension of the operation of returning the accelerator 12 to the closed position. Moreover, because the operation of the accelerator 12 in the further closing direction from the totally closed position of the accelerator 12 can be performed as the extension of the operation of returning the accelerator 12, the rider can easily operate the accelerator 12 when the rider intends to decelerates the vehicle. In other words, the detecting of the rider's intention to decelerate the vehicle during a constant-running speed control by detecting whether the rider operates the accelerator 12 in the further closing direction from the totally closed position of the accelerator 12 provides an optimum method for obtaining an operational input for a straddle-type vehicle. Accordingly, with the control device 100, it is possible to provide a straddle-type vehicle having extremely excellent operability when constant-running speed control is performed.

Still further, in this embodiment, the deceleration processing program 105 decreases the target vehicle speed stored in the first storage means 101 while the first detection program 104 detects or determines whether the above-mentioned operation is being performed. That is, while the rider operates the accelerator 12 in the further closing direction from the totally closed position of the accelerator 12, the deceleration processing program 105 decreases the target vehicle speed. Thus, when the rider operates the accelerator 12 in the further closing direction from the totally closed position of the accelerator 12 to decrease the target vehicle speed of the constant-running speed control to thereby bring the vehicle speed of the straddle-type vehicle to a suitable value, if the rider stops the operation, the constant-running speed control is performed at the new vehicle speed and hence the rider can easily adjust the vehicle speed of the constant-running speed control.

In this embodiment, the deceleration processing program 105 is configured to decrease the target vehicle speed stored in the first storage means 101 based on a previously specified deceleration value while the first detection program 104 detects the above-mentioned operation. For example, if the stored deceleration value is a, the deceleration processing program 105 can decelerate the vehicle by a speed of (a×t) with respect to the period of time t during which the first detection program 104 detects that the accelerator 12 is operated in the further closing direction from the totally closed position of the accelerator 12. For example, it is possible to make the target vehicle speed decrease by 5 km/hr with respect to an operating time of 1 second during which the accelerator 12 is being operated in the further closing direction from the totally closed position of the accelerator 12. Further, if the deceleration processing program 105 is configured in this manner, the rate at which the vehicle speed is decreased with respect to time is constant for the rider. As a result, the rider can easily determine when to stop the operation.

Furthermore, the deceleration processing program 105 can also be configured in such a way that the rate at which the target vehicle speed is decreased with respect to time is changed according to the magnitude of the operating force the rider applies to operate the accelerator 12 in the further closing direction from the totally closed position of the accelerator 12. For example, the deceleration processing program 105 can be configured such that the rate at which the target vehicle speed is decreased with respect to time is increased with the magnitude of the operating force applied by the rider. Consequently, when the rider wants to decelerate the vehicle more quickly, it suffices that the rider applies a large operating force to the accelerator 12, whereas when the rider wants to decelerate the vehicle more slowly, it suffices that the rider applies a small operating force to the accelerator 12, which results in improving the operability of decelerating the vehicle. Moreover, the rider can easily decelerate the vehicle as quickly and smoothly as the rider intends. Thus, the rider can enjoy improved vehicle operability.

In this regard, the control device 100 is preferably provided with a second detection program or routine 106 for determining the magnitude of the operating force, and a first setting means 107 for setting the relationship between the magnitude of the operating force detected by the second detection program 106 and the rate at which the target vehicle speed is decreased with respect to time according to the magnitude of the operating force.

The second detection program 106 is configured to detect the magnitude of the operating force, for example, on the basis of the detection signal input from pressure detection means (operating force detection means) 40. The first setting means 107 stores information on the relationship, in, for example, a table, between the magnitude of the operating force detected by the second detection program 106 and the rate at which the target vehicle speed is to be decreased with respect to time according to the magnitude of the operating force in the storage means of the control device 100. The relationship can be arbitrarily set in advance. It suffices to change the rate at which the target vehicle speed is decreased with respect to time according to the magnitude of the operating force detected by the second detection program 106 on the basis of the relationship between the magnitude of the operating force detected by the second detection program 106 and the rate at which the target vehicle speed is decreased with respect to time according to the magnitude of the operating force, the relationship having been previously set by the first setting means 107. The second detection program 106 and the first setting means 107, which have been described above, are only exemplary means for implementing a control device 100 for a straddle-type vehicle so that the rate at which the target vehicle speed is decreased with respect to time according to the magnitude of the operating force. Other suitable implementations may be used for control device 100.

Up to this point, a control device 100 according to one embodiment and a straddle-type vehicle according to one embodiment have been described. However, configurations of the control device 100 and the straddle-type vehicle 10 according to the present invention are not limited to the above-described embodiment.

For example, the deceleration processing program 105 may be configured in such a way as to decrease the target vehicle speed at a predetermined rate for each specified period of time while the first detection program 104 detects the above-mentioned operation is being carried out. For example, if the rate of target vehicle speed decrease is b % and the present target vehicle speed is S, then the target vehicle speed can be decreased by a speed of S (km/h)×b×0.01×1(s) with respect to each period of time t (s) equal to 1 second during which the first detection program 104 detects that the accelerator 12 is operated in the further closing direction from the totally closed position of the accelerator 12. Specifically, for this example, it is assumed that the rate of target vehicle speed decrease is 5% and that the present target vehicle speed is 100 km/h. In such case, the target vehicle speed is decreased by 5% per the period of time of 1 second during which the accelerator 12 is operated in the further closing direction from the totally closed position of the accelerator 12. In other words, the following control can be realized: in the first period of time of 1 second, the target vehicle speed is decreased by a speed of 5 km/h (=100 (km/h)×5×0.01×1(s)), thereby being decreased to 95 km/h; then, in the next period of time of 1 second, the target vehicle speed is decreased by a speed of 4.75 km/h (=95 (km/h)×5×0.01×1(s)), thereby being decreased to 90.25 km/h. Decreases may be similarly calculated for each ensuing 1 second period. With this configuration, the rider can easily predict the rate at which the vehicle speed is decreased with respect to time, and, as a result, the rider can easily determine the timing of when to stop the operation.

Moreover, the deceleration processing program 105 may be configured in a way that every time the first detection program 104 detects that the accelerator 12 is being operated in the further closing direction from the totally closed position of the accelerator 12, the target vehicle speed stored in the first storage means 101 is decreased. In this case, the deceleration processing program 105 may be configured, for example, in such a way that every time the first detection program 104 detects the above-mentioned operation, the target vehicle speed stored in the first storage means 101 is decreased by a pre-determined amount. For example, the deceleration processing program 105 can be configured to decrease the target vehicle speed by 1 km/h to 2 km/h every time the rider operates the accelerator 12 in the further closing direction from the totally closed position of the accelerator 12. Also in this case, the rider can easily adjust the target vehicle speed. In this regard, as for how much the deceleration processing program 105 decreases the target vehicle speed every time the rider operates the accelerator 12 in the further closing direction from the totally closed position of the accelerator 12, it suffices that the magnitude of the decrease in the target speed is set to a value in consideration of the operability of the straddle-type vehicle.

Still further, for example, the deceleration processing program 105 may be configured such that when the deceleration processing program 105 decreases the target vehicle speed stored in the first storage means 101 every time the first detection program 104 detects the above-mentioned operation, the deceleration processing program 105 changes the degree of decreasing the target vehicle speed according to the magnitude of the operating force of the operation. Specifically, it is preferable for the deceleration processing program 105 to store an arbitrary correlation between the magnitude of the operating force and the degree of decreasing the target vehicle speed in a storage means and to set the degree of decreasing the target vehicle speed on the basis of the stored correlation. Moreover, it suffices to detect the magnitude of the operating force by the second detection program 106. For example, the deceleration processing program 105 can be configured such that every time the accelerator 12 is operated in the further closing direction from the totally closed position of the accelerator 12, the second detection program 106 is called to determine the magnitude of an operating force, and according to the magnitude of the operating force detected by the second detection program 106, when a large operating force is inputted, the deceleration processing program 105 would decrease the target vehicle speed greatly, whereas when a small operating force is inputted, the deceleration processing program 105 would decrease the target vehicle speed slightly. In this case, for example, as for the magnitude of the operating force, it suffices to preset one or more threshold values and to divide the magnitude of the operating force stepwise according to the threshold values. It also suffices to preset the magnitude of the operating force and the amount of decrease in the target vehicle speed stepwise in such a way that when the operating force is relatively large, the amount of decrease in the target vehicle speed is enlarged accordingly. Further, the arbitrary correlation determined between the magnitude of the operating force and the degree of decreasing the target vehicle speed does not need to be stepwise but may be set in such a way that the degree of decreasing the target vehicle speed is smoothly changed with respect to the magnitude of the operating force. In this manner, when the deceleration processing program 105 is configured in such a way that the degree of decreasing the target vehicle speed is changed according to the magnitude of the operating force of the operation, the rider can adjust the amount of decrease in the target vehicle speed by the magnitude of the operating force. This type of setup can improve the operability of the straddle-type vehicle.

Still further, the deceleration processing program 105 may be configured in such a way that every time the first detection program 104 detects that the accelerator 12 is operated in the further closing direction from the totally closed position of the accelerator 12, the amount of decreasing the target vehicle speed is changed according to the vehicle speed when the operation is detected. For example, the deceleration processing program 105 may be configured such that when the vehicle speed when the operation is detected is 100 km/h, the target vehicle speed of the constant-running speed control is decreased by 10 km/h, and when the vehicle speed when the operation is detected is 50 km/h, the target vehicle speed of the constant-running speed control is decreased by 5 km/h. In this case, it suffices that the correlation between the vehicle speed when the operation is detected and the degree of decreasing the target vehicle speed is preset and that the degree of decreasing the target vehicle speed is determined on the basis of the preset correlation.

Still further, the configuration of the deceleration processing program 105 in which every time the first detection program 104 determines that the accelerator 12 is operated in the further closing direction from the totally closed position of the accelerator 12 and the degree of decreasing the target vehicle speed is changed according to the vehicle aped when the operation is detected is not limited to the construction in the above-mentioned embodiment. In another embodiment, for example, the deceleration processing program 105 may be configured in such a way that the rate at which the target vehicle speed is decreased with respect to time when the accelerator 12 is operated in the closing direction is determined in advance and that the target vehicle speed is decreased by the rate. Specifically, for example, the rate at which the target vehicle speed is decreased with respect to time when the operation is detected may be determined to be 10% in advance. In this case, in the case where the constant-running speed control is performed at a target vehicle speed of 100 km/h, when the first detection program 104 detects the operation, the target vehicle speed is decreased by 10 km/h and hence the target vehicle speed is brought to 90 km/h. Further, in the case where constant-running speed control is performed at a target vehicle speed of 90 km/h, when the first detection program 104 detects the operation, the target vehicle speed is decreased by 9 km/h and hence the target vehicle speed is brought to 81 km/h. In this manner, for example, it is also recommendable that the rate at which the target vehicle speed is decreased with respect to time when the accelerator 12 is operated in the closing direction is determined in advance and that, every time the first detection program 104 detects the operation, the target vehicle speed is decreased by the rate according to the target vehicle speed at that time.

Moreover, when the deceleration processing program 105 decreases the target vehicle speed, the deceleration processing program 105 may change the degree of decreasing the target vehicle speed according to the opening of the throttle valve when the first detection program 104 detects the above-mentioned operation. As shown in FIG. 1, the deceleration processing program 105 may change the degree of decreasing the target vehicle speed on the basis of the information regarding the opening of the throttle valve 14 detected by the throttle position sensor 24 when the first detection program 104 detects the above-mentioned operation. Further, the deceleration processing program 105 may be configured such that when the deceleration processing program 105 decreases the target vehicle speed, the deceleration processing program 105 changes the degree of decreasing the target vehicle speed according to a driving torque when the first detection program 104 detects the above-mentioned operation. That is, in this case, as for the driving torque, although not shown, the driving torque of the crankshaft of the engine of the straddle-type vehicle, the main shaft after a first deceleration, or the driving shaft of the rear wheel is detected, and the deceleration processing program 105 may be configured in such a way as to change the degree of decreasing the target vehicle speed on the basis of the driving torque when the first detection program 104 detects the above-mentioned operation.

In this manner, the deceleration processing program 105 may be configured in such a way as to decrease the target vehicle speed stored in the first storage means 101 every time the first detection program 104 detects the above-mentioned operation. In that case, when the deceleration processing program 105 decreases the target vehicle speed, the deceleration processing program 105 may decrease the target vehicle speed by a previously determined speed. Moreover, the deceleration processing program 105 may be configured such that when the deceleration processing program 105 decreases the target vehicle speed, the deceleration processing program 105 changes the degree of decreasing the target vehicle speed according to the magnitude of the operating force. Further, the deceleration processing program 105 may be configured such that when the deceleration processing program 105 decreases the target vehicle speed, the deceleration processing program 105 would change the degree of decreasing the target vehicle speed according to the vehicle speed when the first detection program 104 detects the above-mentioned operation.

Further, in the above-described embodiment, the pressure detection means 40 fixed to the accelerator 12 has been described by way of example as a sensor for detecting the operation and the operating force when the accelerator 12 is operated in the further closing direction from the totally closed position of the accelerator 12, but the position at which the pressure detection means 40 is fixed is not limited to the accelerator 12. For example, as for the position where the pressure detection means 40 performing the function is fixed, in the above-mentioned embodiment, as shown in FIG. 1, the pulley 42 is fixed to the accelerator 12 via cable 41, and when the accelerator 12 is turned, the pulley 42 is turned accordingly. For this reason, the pulley 42 may have a sensor fixed thereto, the sensor detecting the operation and the operating force when the accelerator 12 is operated in the further closing direction from the totally closed position of the accelerator 12.

The control device 100 can be mounted in various kinds of straddle-type vehicles. The term “straddle-type vehicle” as used in this application includes two-wheeled motor vehicles, such as a motorcycles, motor-assisted bicycles (motorbikes) and scooters. Moreover, the term “straddle-type vehicle” includes not only two-wheeled motor vehicles but also four-wheeled buggies (ATV: All Terrain Vehicle) and snowmobiles.

Furthermore, in the above-mentioned embodiments, the construction in which an internal combustion engine having its output adjusted by the opening of the throttle valve is used as the drive source (engine) has been described as an example. In this case, the control device 100 is provided with the throttle valve opening control program 103 (as an output control means) for controlling the opening of the throttle valve 14. However, the drive source is not limited to an internal combustion engine in the straddle-type vehicles of the present invention. Other drive sources, such as an electric motor, can be employed for driving the straddle-type vehicle. In this case, the output control program 103 has the function of controlling the output of the drive source.

It is to be clearly understood that the above description was made only for purposes of an example and not as a limitation on the scope of the invention as claimed herein below.

What is claimed:

1. A control device having a processor for performing a constant-running speed control for a straddle-type vehicle having an accelerator, the control device comprising:
a first storage means configured to store a target cruise control speed;
an input for receiving a detection signal representative of whether the accelerator is operated in a further closing direction from a totally closed position;
instructions for execution by the processor to detect if the vehicle accelerator is operated in a further closing direction from a totally closed position of the vehicle accelerator based upon the detection signal; and
instructions for execution by the processor to decrease the target cruise control speed stored in the first storage means when the further closing operation is detected during a constant-running speed control operation.

2. The control device of claim 1, wherein the target cruise control speed stored in the first storage means is decreased while the further closing operation is detected.

3. The control device of claim 2, wherein the stored target cruise control speed is decreased at a rate previously determined with respect to time while the further closing operation is detected.

4. The control device of claim 3, wherein the pre-determined rate changes according to the magnitude of an operating force utilized in the further closing operation.

5. The control device of claim 4, further comprising instructions that are executable by the processor for determining the magnitude of the operating force utilized in the further closing operation based on a detection signal representative of the magnitude of the operation force, and a stored relationship between detected operating force magnitudes and applicable pre-determined rates, wherein the pre-determined rate changes according to the magnitude of the operating force detected and the stored relationship.

6. The control device of claim 5, wherein the detection signal representative of whether the accelerator is operated in a further closing direction from a totally closed position and the detection signal representative of the magnitude of the operating force utilized in the further closing operation are the same detection signal.

7. The control device of claim 1, wherein the target cruise control speed stored in the first storage means is decreased at a pre-determined deceleration rate while the first detection program detects the further closing operation.

8. The control device of claim 1, wherein the target cruise control speed stored in the first storage means is decreased every time the further closing operation is detected.

9. The control device of claim 8, wherein the target cruise control speed is decreased by a pre-determined amount each time the further closing operation is detected.

10. The control device of claim 8, further including instructions that are executable by the processor to change the degree of decreasing the target cruise control speed according to the magnitude of an operating force applied during the further closing operation.

11. The control device of claim 8, further including instructions that are executable by the processor to change the degree of decreasing the target cruise control speed according to the vehicle speed when the further closing operation is detected.

12. The control device of claim 8, further including instructions that are executable by the processor to change the degree of decreasing the target cruise control speed according to the opening of a throttle valve when the further closing operation is detected.

13. The control device of claim 8, further including instructions that are executable by the processor to change the degree of decreasing the target cruise control speed according to a detection signal representative of a driving torque when the further closing operation is detected.

14. A straddle-type vehicle equipped with the control device of claim 1.

15. The straddle-type vehicle of claim 14, further comprising an operation detection means for generating a detection signal representative of whether the accelerator is operated in the further closing direction from the totally closed position of the accelerator, the operation detection means operatively connected to the input of the control device.

16. A straddle-type vehicle equipped with the control device of claim 5 or 10.

17. The straddle-type vehicle of claim 16, further comprising an operating force detection means for generating a detection signal representative of the magnitude of the operating force utilized when the accelerator is operated in the further closing direction from the totally closed position of the accelerator, the operation force detection means being operatively connected to the control device.

18. The straddle-type vehicle of claim 17, wherein the instructions for determining the magnitude of the operating force are configured to determine the magnitude of the operating force based on the detection signal generated by the operating force detection means.

19. The straddle-type vehicle of claim 18, wherein the operation detection means and the operating force detection means comprise the same detection means and the detection signal representative of whether the accelerator is operated in a further closing direction from a totally closed position and the detection signal representative of the magnitude of the operating force utilized in the further closing operation are the same detection signal.

20. The straddle-type vehicle of claim 14, further comprising an internal combustion engine as a drive source.

21. The straddle-type vehicle of claim 20, further comprising a mechanism for adjusting the output of the internal combustion engine by adjusting an amount a throttle valve is opened, wherein the control device controls the opening of the throttle valve in such a way that the straddle-type vehicle runs constantly at a target cruise control speed stored in the first storage means during the constant-running speed control operation.

22. The control device of claim 1, further comprising a plurality of inputs for sensors configured to detect the respective operational state of a vehicle clutch lever, the vehicle accelerator, a front brake lever, a throttle valve, and a rear brake pedal.

23. A method for performing a constant-running speed control for a straddle-type vehicle having an accelerator, the method comprising:
determining if the vehicle accelerator is operated in a further closing direction from a totally closed position of the vehicle accelerator; and
decreasing a target cruise control speed when the further closing operation is detected during a constant-running speed control operation.

24. One or more device readable mediums for performing a constant-running speed control for a straddle-type vehicle having an accelerator, the one or more device readable mediums storing instructions which, when executed by a processor, cause the processor to perform the device-implemented steps of:
storing a target cruise control speed in a first storage means;
determining, based upon a detection signal, if the vehicle accelerator is operated in a further closing direction from a totally closed position of the vehicle accelerator; and
decreasing the target cruise control speed stored in the first storage means when the further closing operation is detected during a constant-running speed control operation.
